(19) United States
(12) Patent Application Publication
(10) Pub. No.: US 2012/0201975 A1
(43) Pub. Date: Aug. 9, 2012

(54) Aqua-printing gelatinous film and aqua-printing method using the same

(76) Inventor: Hung-Tu Chen, Taichung City (TW)

(21) Appl. No.: 12/929,598

(22) Filed: Feb. 3, 2011

(51) Int. Cl. C08J 7/18; B32B 3/18

(52) U.S. Cl. 427/553; 428/201

(57) ABSTRACT

Disclosed is aqua-printing gelatinous film and aqua-printing method using the same, in which a UV coating layer is formed on the surface of a water soluble gelatinous film, and a pattern is printed thereon, after that a protecting layer is covered over there so as to make up the aqua-printing gelatinous film which is brought to print on the surface of a working piece. Then the work piece is radiated with the UV ray from a UV lamp thereby pattern is fixedly printed on the work piece. The working process is simple, efficient and neat without causing pollution.

### BACKGROUND OF THE INVENTION

1. Field of the Invention

The present invention relates to aqua-printing gelatinous film and aqua-printing method using the same, in which a UV coating layer is formed on the surface of a gelatinous film, and a pattern is printed on the UV coating layer, after that a protecting layer is covered over there so as to make up the aqua-printing gelatinous film which is brought to print on the surface of a working piece. Then the working piece is radiated with the UV ray from a UV lamp thereby the pattern is fixedly printed on the working piece. The working process is easy and efficient.

2. Description of the Prior Art

Forming a pattern on the surface of an irregularly shaped object is but a common technique for person's skill in the art. The Taiwan Patent Publication No. 471392 disclosed an aqua-printing apparatus comprising a gelatinous transportation means, a rotary press assembly, an electric heater wire cutter and a water tank for immersing the work piece. Wherein the water soluble gelatinous film is transported with the transportation means to the rotary press assembly where the film surface is covered with an activator, and then sliced into pieces of appropriate size with the cutter. Finally the work pieces are immersed into the water tank.

However, the aforesaid method of No. 471392 has following distinct flaws:

1. The gelatinous film is elongated using the pull rope of the wheel shaft lengthened by another pulling device such that the wrinkles and creases of the film caused by the ambient humidity can not be rectified.

2. Adhesion of liquid activator to the gelatinous film with a PU foaming wheel in a printing tank and then spreading the activator on the surface of the film never works satisfactorily as expected, for the pores on the surface of the PU wheel will be clogged. As a result, the adhesion efficiency is lowered, and the performance of the sub-printing wheel will be deteriorated too.

For improving the above disadvantages, the inventor of the present invention submitted a second application No. 92208154 “Improved Water Surface Three Dimensional Printing Device”, and it was patented by Taiwan Pat. No. 224311.

It is understood that the conventional aqua-printing gelatinous film is prepared in the way at first coating a PU printing ink on its surface, after being parched and wound up, it is transported to the warehouse to store for use in time of need. When using it, at first an activator is spray coated on its surface, and printed onto the work piece surface with a PU printing ink. But owing to poor adhesiveness to the work piece, the PU printing ink must be additionally applied a protective surface painting by spraying and then parching. The procedure is not only rather complicated but also brings about an environmental air pollution harmful to the operation personnel by the fact a large amount of solvent has to be used during working process.

Besides, during the steps beginning from transporting gelatinous film; activator spray coating; activating the gelatinous film; printing; washing with water; parching; surface coating to the final parching, at least 120 minutes is necessary for the above mentioned conventional product. The resulted high production cost and time loss causes the conventional methods to lose competitiveness.

Besides, the average pattern layer hardness of the work piece made according to the conventional aqua-printing methods is below 1H being unable to withstand the radiation of the UV ray resulting in poor color stability.

### SUMMARY OF THE INVENTION

Accordingly, the object of the present invention is to provide an improved aqua-printing gelatinous film and aqua-printing method using the same wherein the printing gelatinous film is made by forming a coated layer on the surface of a water soluble gelatinous film by spraying UV coating material; next printing a desired pattern thereon, and finally applying a protective layer on the pattern; afterwards the work piece is wound up and stored, preparing to be transported to the place for use.

In the present invention, when performing printing operation, the gelatinous film is activated with an UV activator, after finishing the printing work, it is only necessary to radiate the UV ray on the work piece with an UV lamp to harden the pattern, this is a feature of the present invention.

In the present invention, those traditional work piece treatment steps such as water soaking, parching, surface spray painting or the like, overall processing time including idle time for waiting is considerably long. On the contrary, only 6 minutes are sufficient to carry out the whole processes according to the present invention, the production efficiency is largely improved, this is another feature of the present invention.

In the present invention, it does not have to use any solvent so as to avoid environmental air pollution that affects the health of the operational personnel. This is one more feature of the present invention.

The hardness of the pattern layer on the finished work piece reaches as high as 2H which is two times as hard as that of conventional one, moreover it is strongly resistive to the UV ray irradiation without the fear of color deterioration. As a result, high quality of products ensures a good marketability. This is still one more feature of the present invention.

### BRIEF DESCRIPTION OF THE DRAWINGS

FIG. 1 is a schematic view showing the production steps of the aqua-printing gelatinous film of the present invention.

FIG. 2 is a schematic view showing the production apparatus of the present invention.

FIG. 3 is an exploded illustrative view of the defined amount activator supplying pump used in the present invention.

FIG. 4 is a schematic view of the UV lamp used in the present invention.

### DETAILED DESCRIPTION OF PREFERRED EMBODIMENTS

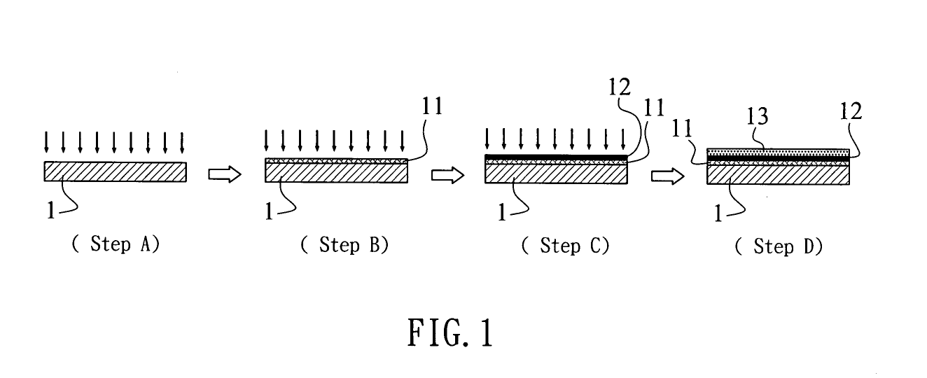

Referring to FIG. 1, in the schematic view which shows the steps of forming the aqua-printing gelatinous film 100, three steps are included namely forming a UV coating layer 11 by spray coating on the surface of a water soluble gelatinous film 1(step A); printing a pattern layer 12 on the UV coating layer 11(step B); and covering a protecting layer 13 on the pattern layer 13 for fixing the pattern (step C) thereby finishing the production steps. Afterwards the finished aqua-printing gelatinous film 100 is wound up and stored in the warehouse for use in time of need.

The UV coating layer 11 to be formed on the surface of the water soluble gelatinous film 1 is a UV coating material preferably composed of resin, dyestuff(pigment), filler and catalyst.

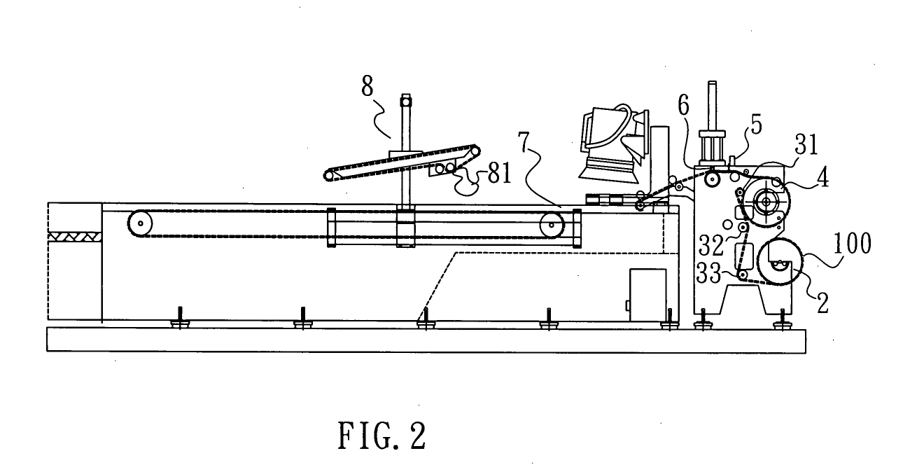

Referring to FIG. 2, the operation of the printing apparatus is illustrated as follows:

1. After the wound gelatinous film 100 is released and developed from the winding drum 2, it is brought to extend onwards by the reels 31, 32, 33 and a gelatinous film flattening roller 4, the roller 4 also serves to keep the surface of the film 100 dry and developed in a slat state.

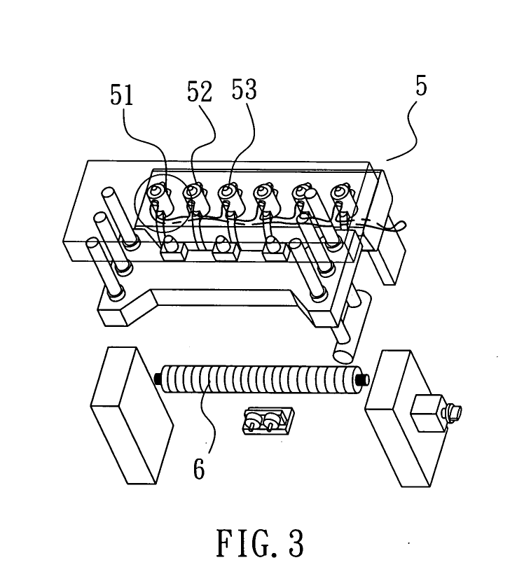

2. The gelatinous film 100 is brought to pass through an activator supplier 5 to receive drops of the liquid UV activator evenly on its surface from a plurality of defined amount activator supplying pumps 51, 52, 53 (see FIG. 3) of the activator. Supplier 5 aligned above the passage of the gelatinous film 100 in an equal distance. The liquid UV activator is dripped in a defined amount and time interval from the pumps 51, 52, 53 under the control of an activator dispensing gauge 6 so as to keep the UV activator able to spread uniformly on the film surface. In this way the UV activator can perfectly react with the UV coating layer 11 on the gelatinous film to perform chemical reduction before film 100 is immersed into the water tank and solved in water.

3. Next, conducting the chemically activated and reduced gelatinous film 100 into a printing tank 7 so as to cause the film 100 perfectly solved in water, and putting a work piece 81 into water with a clamping device 8 for printing a desired pattern.

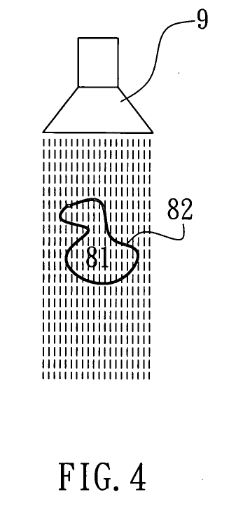

4. After completing the pattern print on the work piece 81, the work piece 81 is taken out of the water tank with the clamping device 81. After that as shown in FIG. 4, the work piece 81 is radiated with a UV lamp 9. By so, the pattern 81 printed on the surface of the work piece 81 may be rapidly hardened in a short time thus finishing the printing work.

It emerges from the above description that the aqua-printing method of the present invention is very effective and advantageous. As the conventional method that the PU printing ink aqua-printing gelatinous film is no more used to cover the surface of the work piece. In stead, the aqua-printing gelatinous film composed of the UV coating layer 11, the printing pattern layer 12 and the protecting coating layer 13 are employed. After finishing the printing work, it is only necessary to radiate the pattern printed on the work piece with a UV lamp 9 to harden the pattern. The hardness of the pattern will be twice higher than that of the pattern formed of the printing ink.

The simplified production steps require only 6 minutes to complete the whole work, the efficiency reaches 20 times that of the conventional one.

Moreover, due to absence of surface printing, it is not necessary for a large amount of solvent. As a result, environmental air pollution is avoided without the worry of affecting the working personnel's health.

It is understood that the present invention is a high level technical creation and by no means simply utilizes a conventional technology or knowledge known to and easily made by persons skilled in the art prior to the application for patent, the invention has neither being published or put to public use, nor displayed in an exhibition, therefore the present invention is entitle for patent.

Although the present invention has been disclosed and illustrated with respect to a preferred embodiment thereof, it is to be understood that the invention is not to be so limited and that other changes and modifications can be made within the full intended scope of the invention as hereinafter claimed.

What is claimed is:

1. An aqua-printing gelatinous film comprising:
a water soluble gelatinous film;
a UV coating layer formed on the surface of said water soluble gelatinous film;
a printing pattern layer formed on said UV coating layer; and
a protective coating layer fixedly formed on the uppermost part of said gelatinous film.

2. The aqua-printing gelatinous film of claim 1, wherein said UV coating layer is composed of resin, dyestuff(pigment), filler and catalyst.

3. Method of printing an aqua-printing gelatinous film comprising the steps:
A. selecting the surface of said aqua-printing gelatinous film as claimed in claim 1;
B. uniformly dispensing a UV activator on the surface of said aqua-printing gelatinous film;
C. bringing said aqua-printing gelatinous film with said UV activator spread on the surface thereof into a printing tank;
D. covering the surface of a work piece with said aqua-printing gelatinous firm; and
E. after printing said pattern on the surface of said work piece, radiating said work piece with a UV lamp so as to rapidly harden and fix said printed pattern on the surface of said work piece.

4. Method of printing as claimed in claim 3, wherein the apparatus for printing comprises:
a film flattening roller for taking out said aqua-printing gelatinous film;
an activator supplier with a plurality of defined amount activator supplying pumps aligned above the passage of said gelatinous film to drip said UV activator on the surface of said passing gelatinous film intermittently;
an activator dispensing gauge for keeping said UV activator dripped on the surface of said gelatinous film to spread uniformly on the film surface such that said UV activator can chemically react with said UV coating layer on said gelatinous film perfectly; and
a printing tank having a clamping device inside for clamping said work piece for printing said pattern from said aqua-printing gelatinous film conducted into said tank.
